(19) United States
(12) Patent Application Publication
(10) Pub. No.: US 2015/0209804 A1
(43) Pub. Date: Jul. 30, 2015

(54) CENTRIFUGAL SEPARATION DEVICE

(71) Applicant: QINZHOU AURASOURCE TECHNOLOGY INC., Qinzhou City, Guangxi (CN)

(72) Inventors: Chuanzhong Zhang, Qinzhou City (CN); Bo Peng, Qinzhou City (CN)

(73) Assignee: QINZHOU AURASOURCE TECHNOLOGY INC., QINZHOU CITY (CN)

(21) Appl. No.: 14/422,145

(22) PCT Filed: Aug. 15, 2013
(86) PCT No.: PCT/CN2013/081508

§ 371 Date: Feb. 17, 2015

(30) Foreign Application Priority Data
Aug. 15, 2012 (CN) 201210290352.6

(51) Int. Cl. B04B 9/10

(52) U.S. Cl. CPC B04B 9/10

(57) ABSTRACT

The present invention relates to a centrifugal separating apparatus for separating fine particles of different densities in slurry. The existing sorting principle of the centrifugal separation apparatus for sorting the fine slurry in terms of specific weight thereof is to utilize the inertia of the slurry flowing with the rotation of a centrifugal drum, so as to keep an appropriate relative movement between the slurry and the drum, thereby producing a laminar flow with a speed gradient. The purpose of sorting in terms of specific weight thereof can be achieved by using the Bagnold's Effect produced in the laminar flow. The disadvantage of the device is that it is not easy to control the speed gradient of the relative movement of the slurry, thereby affecting an effect of separation. The present invention discloses a centrifugal device, which applies a power activation with a controllable strength onto the slurry materials in a centrifugal force field by means of a mechanical activation device, and enables the slurry materials to produce a laminar flow with an appropriate speed gradient relative to the centrifugal device, thereby promoting the Bagnold's Effect and achieving the purpose of precisely sorting.

### TECHNICAL FIELD

The present invention relates to a centrifugal separating apparatus for separating fine particles of different densities within slurry.

### BACKGROUND ART

Among the current centrifugal separating apparatus for separating fine particles of different densities within slurry, which have been used in a wide commercial application, there is a type of centrifuge with a bowl-like drum. This centrifuge has been initially disclosed in the Canada Patent CA1111809A1, and improved and promoted continuously in a subsequent series of patents or patent applications (including U.S. Pat. No. 4,608,040, U.S. Pat. No. 4,846,781, U.S. Pat. No. 5,338,284, U.S. Pat. No. 5,462,513, U.S. Pat. No. 5,586,965, U.S. Pat. No. 5,601,523, U.S. Pat. No. 6,149,572, U.S. Pat. No. 6,796,934, US2004013260, US20050026766, US20060135338), and referred to as Knelson centrifugal separation machine or Falcon centrifugal separation machine. The main structure of this type of centrifugal separating apparatus includes a vertical bowl-like drum which is rotatable with a high speed, and one or more annular chutes at the outer peripheral wall of the drum. A feeding pipe leads to the bottom of the drum, and at the bottom of the drum, there is provided with vanes which can accelerate the rotation of materials. In these technical solutions, some provide a liquid injection device within the chutes, which can protect the materials from sinking or depositing in the chutes, and others provide throttle nozzles which can discharge heavy materials successively. The operational principle is: The slurry to be treated, enters the drum through a vertical feeding pipe centrally disposed in the machine, and the minerals, under a strengthened gravity field of up to 50-300 G, moves outside upward, while layering along the inner wall of the drum in terms of different densities. Upon arrival of the materials at the chutes, the heaviest part is collected at the bottom of the chutes, or flows out of the drum continuously via a series of throttle valves, and enters a heavy-material collection output channel, while the lighter components fly out of the upper edge of the drum, and enter a light-material collection output channel. The particle sorting of this type of apparatus conforms to a separation layering law, that is, the particles with different densities and sizes are layered and distributed in the order of heavier small particles, heavier large particles, lighter small particles and lighter large particles in a bottom-to-top direction. Since the thin-layered slurry has a higher kinematic speed relative to the inner wall of the drum or chutes during the layering process, the layered particles tend to be mixed, which would become more apparent when the particle sizes are relatively small. Hence, in case that the apparatus are utilized for removing the ash and sulfur within coal, when the particle sizes are smaller than a certain threshold value, separating effects thereof would rapidly decline, or even the apparatus would fail to work. In the reported practice, the smallest effective separation particle size is 37 μm, and otherwise, ineffective separation would appear if the particle size is smaller than this value.

China patent application No. 201010123864.4 discloses a centrifugal separating device, which comprises a separation cavity, a feeding port, at least one heavy-material outlet with chutes, and at least one light-material outlet. Material acceleration devices, such as radial baffles or turbines, are provided at the feeding channel between the feeding port and the separation cavity, and constitute a material differential rotation pushing device by mating with various forms of the separation cavities, which device enables the slurry entered the separation cavities to rotate with the separation cavities, keeps the rotational speed of the slurry distinctive appropriately to that of the distinctive cavities, and pushes the slurry to finally discharge the cavities through material outlets. The device makes full use of the separation effect and can layer and effectively separate the finer slurry particles in terms of densities without increasing the centrifugal acceleration.

The disadvantages of the device are: In case that the concentration of the slurry is high, laminar flow tends to be formed even if the flow velocity of the slurry is high, and some sediments are formed at the outer wall of the separation cavities, resulting in that it is hard for the materials with high densities to be discharged continuously and smoothly. Thus, when setting the parameters for the separating operation, low slurry densities or high differential speeds between the slurry and separation cavity has to be taken, thereby decreasing the operation efficiency and separation accuracy, and increasing the lower limit of the particle sizes to be separated.

### SUMMARY OF THE INVENTION

The present invention discloses the same separating principle as that of the aforementioned centrifugal separating device, which changes the way of driving the slurry materials and the separation cavity to move relative to each other from using the inertia of the materials to using a mechanical device for driving, so as to precisely control the relative movement of the slurry materials and the separation cavity.

In particular, the centrifugal separating apparatus for sorting different particle components from slurry materials in terms of specific weight thereof comprises a centrifugal device that is rotated to produce a centrifugal force field, the slurry materials are placed into or pass through continuously the centrifugal force field, wherein the centrifugal separation apparatus further comprises a mechanical activation device that applies a power activation with a controllable strength onto the slurry materials in the centrifugal force field, and enables the slurry materials to produce a laminar flow with an appropriate speed gradient relative to the centrifugal device.

The laminar flow with an appropriate speed gradient in the centrifugal force field brings about a maximum Bagnold's Effect, such that the particles of the slurry materials are separated and layered in terms of different specific weights and sizes. If the slurry flows too quickly, turbulence may occur readily, which may fail the layering process, while if the slurry flows too slowly, sedimentation may occur readily.

In the technical solution of placing the materials into the centrifugal force field, the operation mode thereof is intermittent, and the apparatus has a relatively simple structure, which is applicable onto small lab devices. The particular technical solution is implemented by providing blades within the cups of a balanced rotor centrifuge for rotationally stirring the materials in the cups during a centrifuging process. The balanced rotor centrifuge herein refers to the centrifugal device, and the blade refers to the mechanical activation device.

Among the technical solutions of passing materials through the centrifugal force field, the continual operation mode is more practical in the industrial applications.

One technical solution of passing materials through the centrifugal force field is:

The centrifugal device in the centrifugal separation device comprises: a drum, capable of rotating about its own center axis under a power drive, with one or two ends open, or both ends closed, and when the drum rotates about its own center axis, the drum allows a rotational motion of the slurry inside the drum; a feeding port, disposed at an inner side of the drum, for delivering the slurry to be separated, into the drum; a heavy material outlet and a light material outlet, disposed at an outer side and a relatively inner side, respectively, or disposed at two ends of the drum respectively, wherein the mechanical activation device is a circular drum-like device with blades, the circular drum-like device is provided inside the drum, contacts with the slurry materials and rotates about a center axis of the drum relative to the drum, the circular drum-like device is referred to as an inner drum and the drum as an outer drum.

According to the movement directions of the heavy/light materials during the separation, the feeding port can be provided at one end of the drum, and the heavy/light material outlets at the other end, such that the heavy/light materials move along the same direction during the separation; the feeding port can also be provided in the middle of the drum, and the heavy/light material outlets at two ends thereof, such that the heavy/light materials move along the opposite directions during the separation, so as to make the separation effects more apparent and the separating ratios more controllable.

Said light material refers to the slurry containing many light specific weight particles and in the same way, said heavy material refers to the slurry containing many heavy specific weight particles. The light and heavy materials are just comparative terms during the same separating process, and sometimes, the slurry with particles of specific weight between the light materials and the heavy materials or containing a comparative ratio of light materials and heavy materials, refers to as middle materials.

The present invention may also be provided with a heavy material anti-adherence device, so as to prevent the heavy materials from adhering to the wall, depositing thereon and interrupting the operation.

The heavy material anti-adherence device may be provided on the drum, which may be a mechanical propelling device, such as a spiral propelling device, the structure of which being similar to that of the prior Decanter Centrifuge.

The anti-adherence device may also be a shaking device. The shaking device may be a mechanical shaking device applying action onto the drum, or a ultrasonic shaking device applying action onto the slurry.

The ultrasonic shaking device may provide an ultrasonic emitter at the inner side of the drum, and submerge the same into the slurry, so as to emit ultrasonic wave to the slurry materials, whereby the vibration of the slurry materials can prevent the slurry particles from adhering onto the outer wall of the drum.

The mechanical shaking device for the drum may be a knocking device, or may be a high-frequency shaking device.

The knocking device is one that knocks the drum positively or negatively along the circumference direction or the center axis direction during the rotation of a drum, such that a relative acceleration arises between the drum and the materials. The knocking device which itself does not have power but acts by means of the power of a drum, is referred to as a negative knocking device, while the knocking device which itself has power, is referred to as a positive knocking device.

The negative knocking device may particularly be one or more protrusions, and on the frame is provided with one or more hammer with an elastic reset device. In such a way, one knock occurs each time when the protrusion of the drum passes by the hammer. The knocking frequency of the negative knocking device is codetermined by the number of the protrusions and the hammers and the rotational speed of the drum.

The positive knocking device itself has power, and may perform the knocking operation with the required frequency. The positive knocking device is of more advantages when knocking in the direction of center axis.

In the high-frequency shaking device of the drum, the shaking direction may be along the direction of center axis of the drum, or may be along the circumference direction thereof. The mechanical structure with the shaking direction in the center axis direction of the drum, can refer to the Mozley centrifuge, only except that the shaking frequency of the Mozley centrifuge is low, and its main function is not to prevent the heavy material from depositing and adhering to the wall.

The mechanical shaking device itself improves the layering effect of the slurry particles in terms of specific weight thereof.

To improve the effect of the separation and the layering, channels or threads with a direction perpendicular to the slurry flow direction may be provided on the inner wall of the drum on which a high-frequency shaking device is disposed. Its operation principle may refer to that of the concentrating table.

### BRIEF DESCRIPTION OF THE DRAWINGS

Hereinafter, the particular technical solutions of the present invention are further illustrated in conjunction with the embodiments and the drawings, in which:

FIG. 1 is a perspective appearance schematic diagram of the main structure of a small centrifugal separating apparatus for intermittent operations;

FIG. 2 is a perspective cut-away schematic diagram of a centrifugal cup with a rotational activation device of the small centrifugal separating apparatus for intermittent operations;

FIG. 3 is a central cross-sectional schematic diagram of the straight panel-like blade centrifugal separating apparatus, with arrows showing the separation process and movement directions of the material when the apparatus is in operation;

FIG. 4 is a perspective appearance schematic diagram of the straight panel-like blade centrifugal separating apparatus;

FIG. 5 is a perspective appearance schematic diagram of the inner drum and the blade of the straight panel-like blade centrifugal separating apparatus;

FIG. 6 is a central cross-sectional schematic diagram of a double helix blade centrifugal separating apparatus, with arrows showing movement directions of the material when the apparatus is in operation;

FIG. 7 is a perspective appearance schematic diagram of the double helix blade centrifugal separating apparatus;

FIG. 8 is a perspective appearance schematic diagram of the inner drum and the blade of the double helix blade centrifugal separating apparatus;

FIG. 9 is a perspective cut-away schematic diagram of the light-material discharging port of the double helix blade centrifugal separating apparatus;

FIG. 10 is a central cross-sectional schematic diagram of the centrifugal separating apparatus with a heavy-material anti-adherence device and a light/heavy-material force discharging device, with arrows showing movement directions of the materials when the apparatus is in operation;

FIG. 11 is a perspective cut-away schematic diagram of the centrifugal separating apparatus with a heavy-material anti-adherence device and a light/heavy-material force discharging device;

FIG. 12 is a perspective appearance schematic diagram of the centrifugal separating apparatus with a heavy-material anti-adherence device and a light/heavy-material force discharging device;

FIG. 13 is a perspective appearance schematic diagram of a shaking drum of the centrifugal separating apparatus with a heavy-material anti-adherence device and a light/heavy-material force discharging device;

FIG. 14 is a perspective appearance schematic diagram of an inner drum of the centrifugal separating apparatus with a heavy-material anti-adherence device and a light/heavy-material force discharging device;

FIG. 15 is a perspective cut-away appearance schematic diagram of the cross section of a vibration driving part of the shaking drum of the centrifugal separating apparatus with a heavy-material anti-adherence device and a light/heavy-material force discharging device.

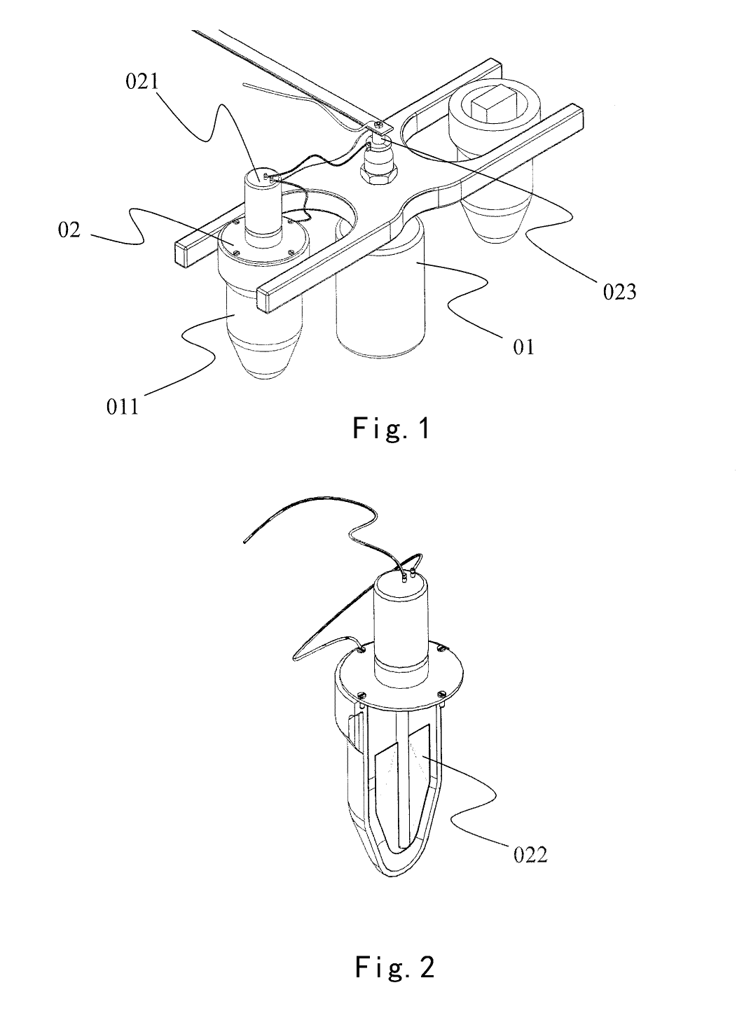

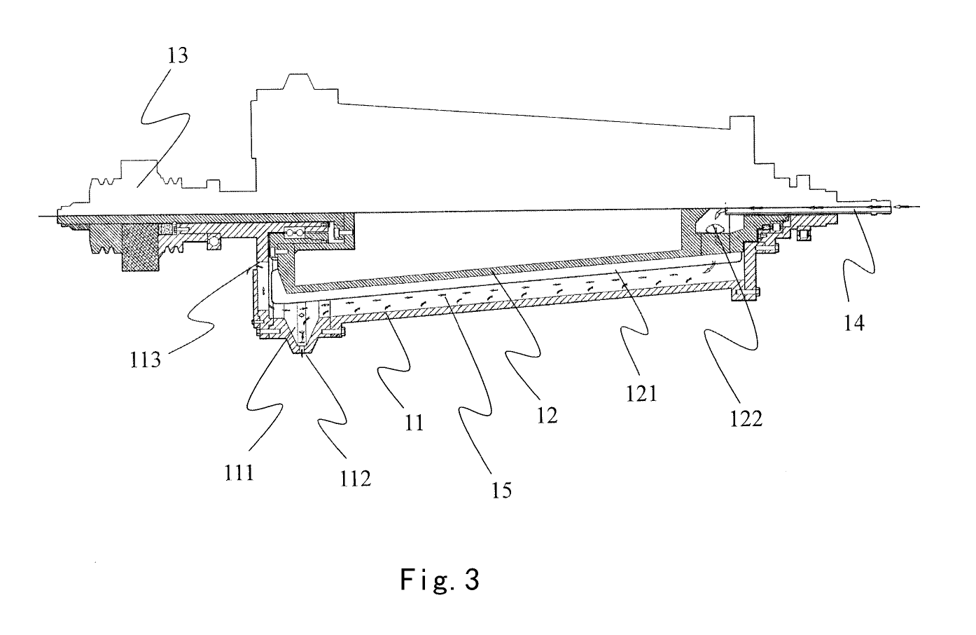

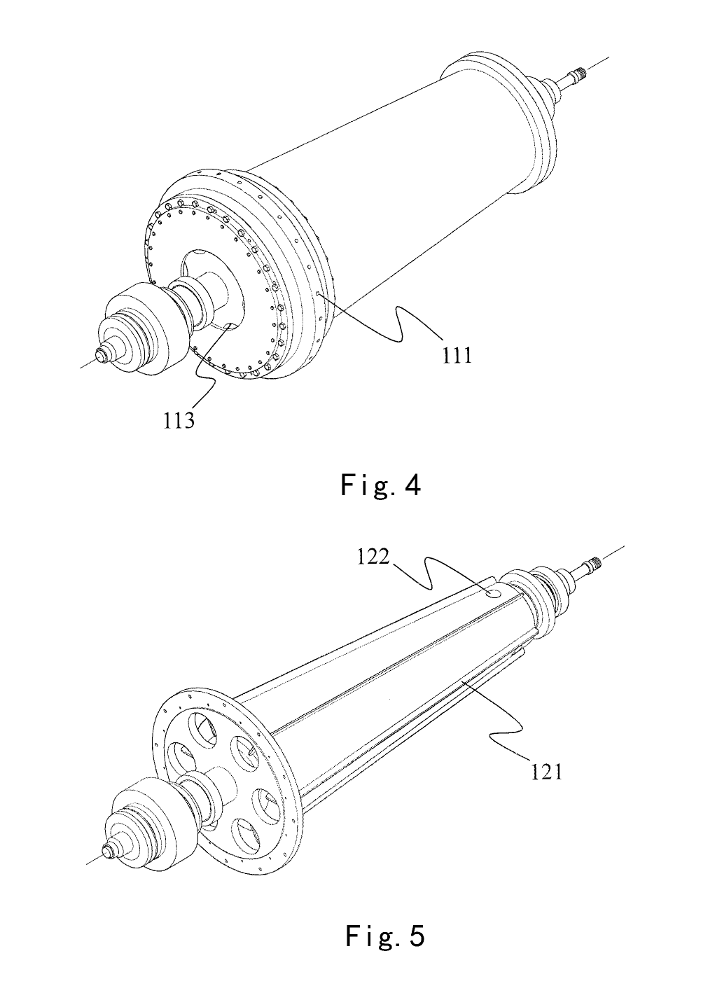

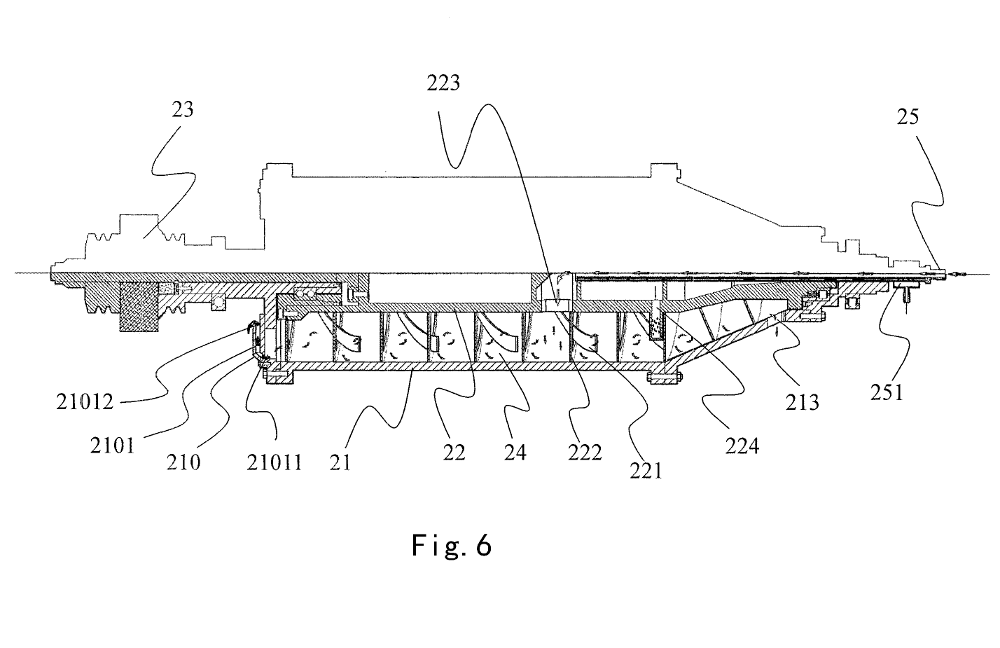

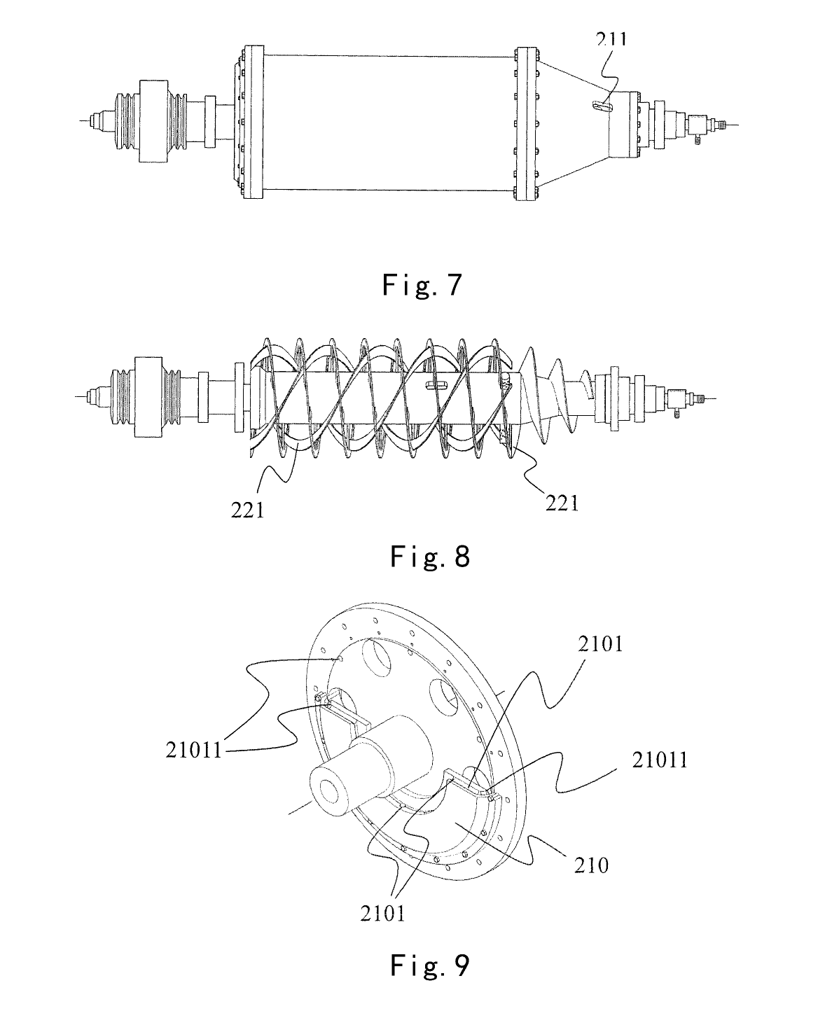

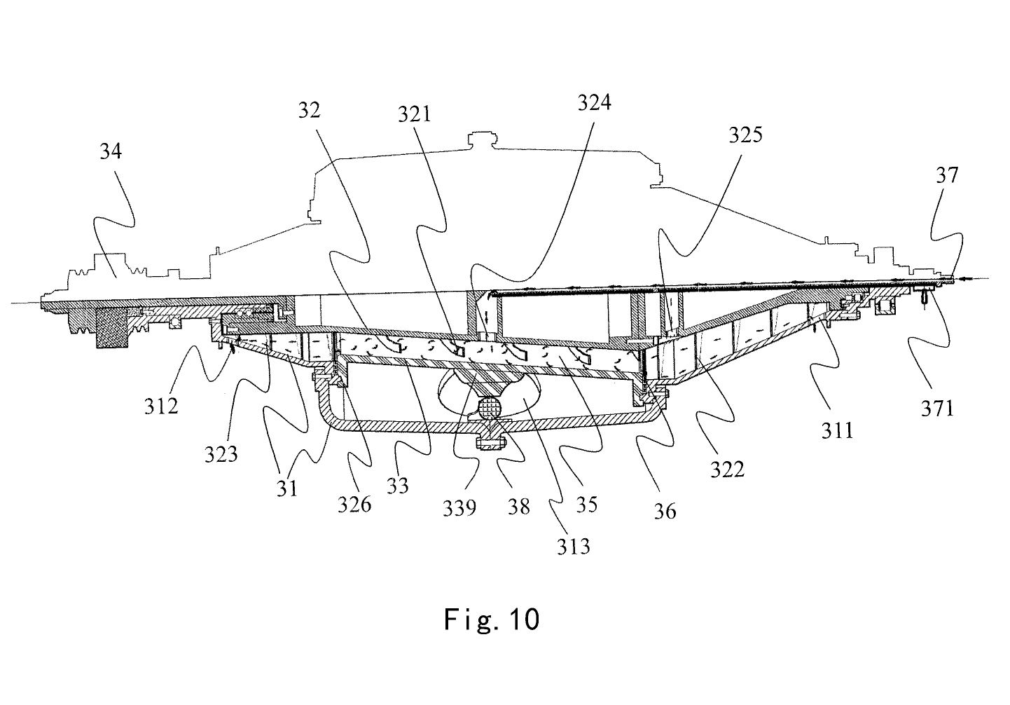

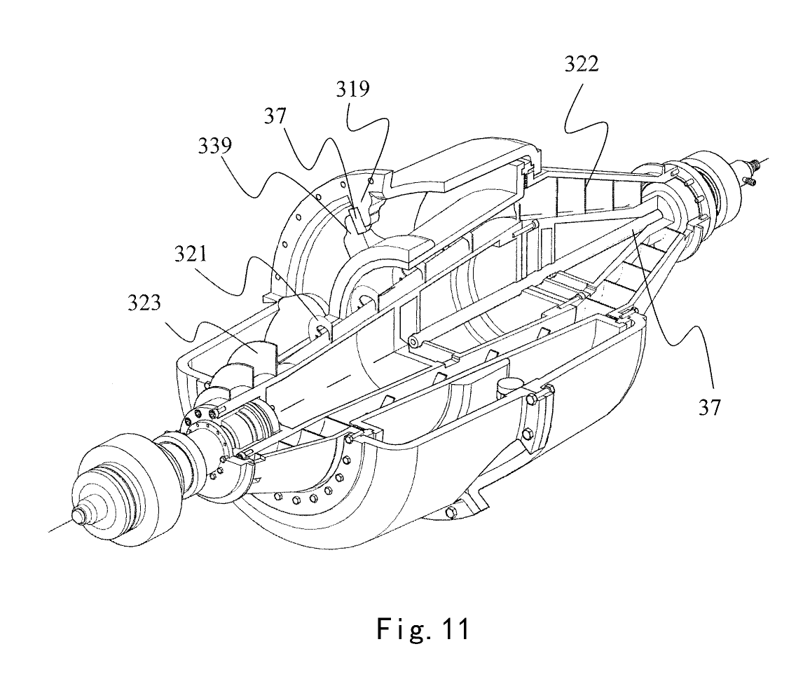

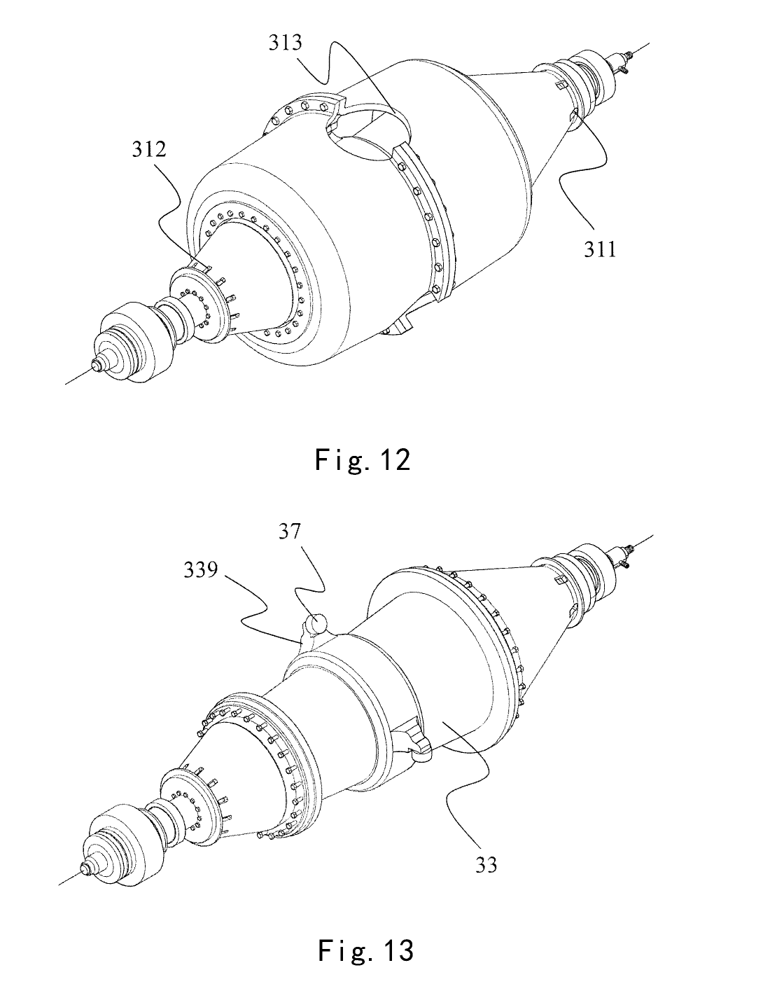

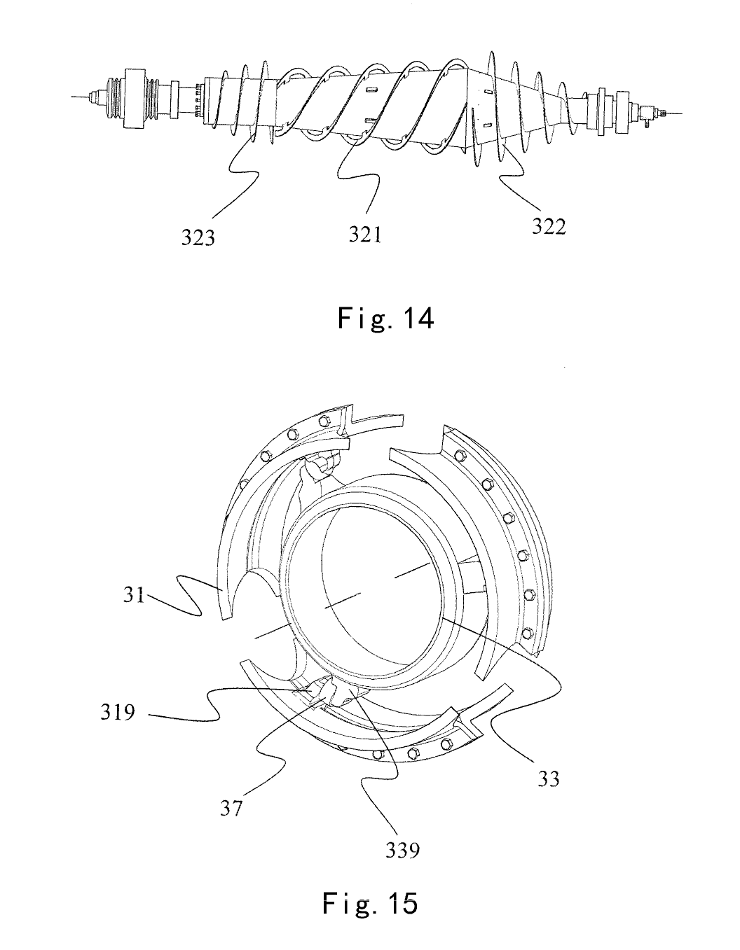

### PREFERABLE MODE OF CARRYING OUT THE INVENTION

### Embodiment 1

### Small Centrifugal Separating Apparatus for Intermittent Operations

The particular technical solution is to provide a rotational activation device 02 in centrifugal cups 011 of an existing balanced rotor centrifuge 01, the rotational activation device 02 can rotationally stir the materials within the cups during centrifuging process. The rotational activation device may be secured at the rim of the centrifugal cups by means of flat-plated stirring blades 022 driven by a DC motor 021. A slip-ring carbon brush 023 is disposed on a center shaft of the centrifuge. One of the two-phase power lines of the DC motor is directly connected to the centrifuge, and the other to the voltage regulating DC power via the slip-ring carbon brush, the other phase of the DC power is connected to the centrifuge. A relatively large gap is left between the edges of the flat-plated stirring blades and the walls of the centrifugal cups.

During operation, slurry materials are placed into the centrifugal cups, and the stirring blades are mounted. Initially, the stirring blades are rotated so as to mix the slurry materials evenly; then the centrifuge is brought into operation until it reaches a certain rotation speed, and kept for a period of time, so that the slurry materials are sufficiently layered. Subsequently, the rotations of the stirring blades are stopped and the rotational speed of the centrifuge is decreased until it stops. The centrifugal cup is taken out, and the layered slurry materials are separated manually.

### Embodiment 2

### Straight Panel-Like Blade Centrifugal Separating Apparatus

The particular technical solution is: the centrifugal device comprises an outer drum 11, an inner drum 12, a differential transmission device 13, a feeding pipe 14, wherein the outer drum is a truncated cone-like hollow drum, a heavy-material outlet 112 and a light-material outlet 113 are respectively disposed at a side face of the outer drum close to the bottom face and at the bottom face of the outer drum. The inner drum served as a mechanical activation device is a truncated cone similar to the shape of the outer drum, and a side face of the inner drum is provided with a plurality of straight panel-like blades 121. The ends with smaller diameters of the inner and outer drums are referred to as top ends, and the ends with larger diameters as bottom ends. The differential transmission device has the same structure as the corresponding parts of an existing Decanter Centrifuge, and serves for driving the outer drum and the discharging spirals to rotate with a preset differential under the driving of an external power. The inner drum of this device corresponds to the discharging spirals of the Decanter Centrifuge. A gap is kept between the straight panel-like blades and the outer drum, and the feeding port 122 is located at the side face close to the top end of the inner drum. The feeding pipe 14, protruding from one end into the inner drum along the centerline thereof, has the same structure as the corresponding structure of the Decanter Centrifuge, which is fixed on the frame, and does not rotate with the inner and outer drums. The cavity between the inner and outer drums is a separation cavity 15, the two ends of which are also referred to as a top end and a bottom end respectively corresponding to those of the inner and outer drums.

When in operation, the raw slurry enters the top end of the separation cavity through the feeding port, and moves spirally toward the bottom end thereof along the separation cavity. During this process, the slurry particles are layered in terms of specific weight thereof, forming a heavy-material layer and a light-material layer. The heavy materials enter the chutes and are discharged through a heavy-material discharging port, while the light materials moves toward the bottom end and the inside, and are discharged through a light-material discharging port.

### Embodiment 3

### Double Helix Blade Centrifugal Separating Apparatus

The apparatus comprises an outer drum 21, an inner drum 22, an activation spiral 221, a heavy-material discharging spiral 222, and a differential transmission device 23. The outer drum is a centrifugal device, and a hollow cavity is constituted by a length of cylinder and a cone, a bottom surface of which matches with the cylinder. The inner drum and the activation spiral act as a mechanical activation device. The inner drum has a similar shape to the outer drum, and the inner drum together with the outer drum, enclose a separation cavity 24. The cylinder and the cone of the inner drum and the outer drum are respectively referred to as a straight section and a conical section, and the interface between the straight section and the conical section is referred to as a shoulder, and the other end of the straight section is referred to as a bottom. A feeding port 223 is provided at an intermediate position of the straight section of the inner drum, and a rinse water inlet port 224 is provided at the straight section close to the cone. The feeding pipe 25 and the rinse water input pipe 251, protruding into the inner drum from one end along the centerline of the inner drum, may be provided as a structure of concentric pipes, wherein the feeding pipe locates inside and the rinse water input pipe locates outside, and they are open respectively at the feeding port and the rinse water inlet port of the inner drum. The feeding pipe is fixed onto the frame, and does not rotate with the inner and outer drums. The rinse water inlet port 224 may be provided as a simple hole, preferably a blind tube with a plurality of pores, protruding into the separation cavity, such that the impact onto the deposited materials by the rinse water can be reduced. The blade of the straight section of the heavy-material discharging spiral is opened with a hole, and the hole is opened as large as possible in the premise of keeping the strength of the spiral, such that the dimension from the peripheral edge of the hole to the peripheral edge of the blade does not exceed one third of the width of the blade. Through opening the hole, an activation spiral with reverse torsion is provided. The pitch of the activation spiral is several times as that of the heavy-material discharging spiral and may be large infinitely, that is, the activation spiral is actually a straight panel. The activation spiral is as close to the peripheral edge of the hole as possible, and has a width not more than one half of the height of the hole, that is, the width of the activation spiral does not exceed one third of the width of the heavy-material discharging spiral blade. The activation spiral serves for not only driving the slurry materials to flow relative to the outer drum and producing a laminar flow with a speed gradient so as to bring about the Bagnold's Effect such that the slurry particles are layered in terms of specific weight thereof, but also rotating the activation spiral relative to the outer drum so as to accelerate the light materials to move towards the bottom end of the separation cavity. A liquid baffle 210 disposed at the bottom of the straight section is provided with several tube-like light-material discharging ports 2101, an internal opening 21011 of which is at the part of the liquid baffle close to the side face of the outer drum, while an external opening 21012 is close to the inner drum. The light-material discharging ports utilize the principle of a communication vessel to discharge the light materials which have arrived at the bottom of the straight section and deposited close to the side face of the outer drum, which is referred to as a communication vessel discharging pipe. A heavy-material discharging port 211 is provided at the conical section of the outer drum close to the cone tip.

The apparatus may also be understood to be improved on the basis of the existing Decanter Centrifuge. The materials push the spirals to open a hole, and an activation spiral with reverse torsion is provided in the hole. The light-material discharging port is changed from overflowing the materials out of the inner edge of the liquid baffle to injecting the materials out of the communication vessel discharging pipe disposed in the liquid baffle.

When in operation, the particles with a larger specific weight among the slurry materials entering the separation cavity from the feeding port, sink toward the outer drum under the effect of the centrifugal force, and move toward the conical section under the push of the heavy-material discharging spirals, and at the same time, the activation spiral brings the intermediate slurry carrying the particles of lower specific weight to move spirally toward the light-material discharging port at the bottom of the outer drum relative to the outer drum. As a compensation movement, the thin slurry inside the separation cavity moves toward the conical section, and forms a local circular flow with the intermediate slurry. The overall movement tendency of the slurry materials in the separation cavity is that the particles of larger specific weight move toward the conical section and finally are discharged out of the heavy-material discharging port in a solid or semi-solid form, while the particles of lower specific weight moves towards the bottom of the outer drum and are discharged out of the light-material discharging port in a slurry form, and the inside thin slurry carrying extremely light particles moves toward the conical section and enters the intermediate slurry, so as to form a cycle.

### Embodiment 4

### Centrifugal Separating Apparatus with a Heavy-Material Anti-Adherence Device and a Light/Heavy-Material Force Discharging Device

The apparatus comprises an outer drum 31, an inner drum 32, a shaking drum 33, an activation spiral 321, a heavy-material discharging spiral 322, a light-material discharging spiral 323 and a power transmission device 34. The two end portions of the inner drum, the shaking drum and the outer drum together enclose a separation cavity 35. The activation spiral, the heavy-material discharging spiral, and the light-material discharging spiral are all secured to the inner drum. The heavy-material discharging spiral and the light-material discharging spiral have opposite torsion directions and contact with or clearance fit to the outer drum. The structure and principle of the heavy/light-material discharging spirals are the same as that of the conical section of the existing Decanter Centrifuge. The activation spiral has the same torsion direction as that of the light-material discharging spiral, and a relatively large gap is left between the activation spiral and the shaking drum, and also a relatively large gap is left between the activation spiral and the inner drum in the form of a hole or connectors indirectly connected. For instance, the activation spiral may be provided at a central position between the inner and outer drums, and the width thereof is one third of the distance between the inner and outer drums. The two ends of the outer drum are cones with opposite bottom faces, and a heavy-material discharging port 311 and a light-material discharging port 312 are respectively disposed at the two ends close to the cone tip. The shaking drum is shaped to be a truncated cone, with a larger diameter at the side close to the heavy-material discharging port, which can be a bottom end, and thus, the other one can be a top end. The shaking drum and the two end portions of the outer drum are connected by a seal ring 36 so as to form a continual outside wall of the separation cavity. The activation spiral serves for not only driving the slurry materials to flow relative to the shaking drum and producing a laminar flow with an appropriate speed gradient so as to bring about the Bagnold's Effect such that the slurry particles are layered in terms of specific weight thereof, but also rotating the activation spiral relative to the shaking drum such that the light materials overcome the centrifugal force to move toward the top end of the truncated cone-like shaking drum. The inside wall of the shaking drum is provided with a helical channel with a torsion direction identical to that of the activation spiral and a pitch slightly smaller than that of the activation spiral. The slightly smaller pitch is intended to enable the direction of the slurry materials flowing relative to the shaking drum produced by the rotation of the activation spiral to be perpendicular to the helix channel. The central portion of the outer drum is located outside of the shaking drum and is integrated with the two end portions of the outer drum as a whole. Several repair windows 313 are provided at the central part of the outer drum for dismounting the components between the outer and inner drums. The two ends of the inner drum are shaped to be cone-like, and the central part thereof is truncated cone-like, and provided with a feeding port 324. The heavy-material discharging cone-like ends close to the bottom portion is provided with a rinse water inlet port 325. The feeding pipe 37 protrudes into the inner drum from one end along the centerline of the inner drum, and the rinse water input pipe 371 may be provided as a structure of concentric pipes of the feeding pipe, wherein the feeding pipe locates inside and the rinse water input pipe locates outside, and they are open respectively at the feeding port and the rinse water inlet port of the inner drum. The feeding pipe is fixed onto the frame, and does not rotate with the inner and outer drums. Two slip fitting connections 326, with a centerline identical to the common rotation centerline of the inner and outer drums, are disposed between the shaking drum and the two end portions of the outer drum, such that the shaking drum and the outer drum can rotate relative to each other. Several pairs of protruding connectors 319 and 339 are provided between the central portion of the outer drum and the shaking drum, and a shaker 38, which can produce simultaneous vibrations, is provided between each pair of the connectors such that the shaking drum may produce a rotational vibration relative to the outer drum in the circumference direction of the rotation. The shaker can obtain the driving power through a conductive slip ring device provided on the centerline of the drum. The conductive slip ring device is a developed art in the current electromechanical apparatus, and will be omitted herein. The shakers available in the market can be subdivided into the mechanical type and the piezoelectric ceramics type, both of which can be configured for use.

When in operation, the particles with a larger specific weight among the slurry materials entering the separation cavity from the feeding port, sink toward the shaking drum under the effect of the centrifugal force, and move toward the heavy-material discharging port under the same, and at the same time the activation spiral brings the intermediate slurry carrying the particles of lower specific weight to move spirally toward the light-material discharging port relative to the shaking drum. As a compensation movement, the thin slurry inside the separation cavity moves toward the heavy-material discharging port, and forms a local circular flow with the intermediate slurry. The heavy materials leaving the shaking drum are dehydrated under the pushing of the heavy-material discharging spiral, and are discharged out of the separation cavity from the heavy-material discharging port in a solid or semi-solid form. The light materials leaving the shaking drum are discharged out of the separation cavity from the light-material discharging port in a slurry form, under the combined pushing of the light-material discharging spiral and the water flow.

The shaking drum enables the rotational vibration produced by the outer drum in the circumference direction to improve the effect of the layering of the slurry particles in terms of specific weight thereof. To further promote this effect, the shaker 38 can also be provided as a complex-frequency vibrator which can produce complex vibrations containing different vibration frequencies, wherein the higher-frequency vibration is used for preventing the heavy materials from adherence, while the lower-frequency vibration is used for improving the effect of the layering of the slurry particles in terms of specific weight thereof.

What is claimed is:

1. A centrifugal separating apparatus for sorting different particle components from slurry materials in terms of specific weight thereof, said centrifugal separation apparatus comprising a centrifugal device that is rotated to produce a centrifugal force field, said slurry materials being placed into or passing through continuously said centrifugal force field, characterized in that said centrifugal separation apparatus further comprises a mechanical activation device that applies a power activation with a controllable strength onto said slurry materials in said centrifugal force field, and enables said slurry materials to produce a laminar flow with an appropriate speed gradient relative to said centrifugal device.

2. The centrifugal separating apparatus according to claim 1, wherein said centrifugal device is a balanced rotor centrifuge, and said mechanical activation device is a blade device that is capable of rotationally stirring said materials in a cup during a centrifuging process.

3. The centrifugal separating apparatus according to claim 1, wherein said centrifugal device comprises: a drum, capable of rotating about its own center axis under a power drive, and allowing a rotational motion of the slurry inside said drum; a feeding port, disposed at an inner side of said drum; a heavy material outlet and a light material outlet, respectively disposed at an outer side and a relatively inner side of the same end of said drum, or respectively disposed at two ends of said drum, wherein said mechanical activation device is a circular drum-like device with blades, said circular drum-like device being provided inside said drum, contacting with said slurry materials and rotating about a center axis of said drum relative to said drum, said circular drum-like device being referred to as an inner drum and said drum as an outer drum.

4. The centrifugal separating apparatus according to claim 3, wherein said outer drum is a truncated cone-like hollow drum, a heavy-material outlet with a chute is disposed at a side face of said outer drum close to a bottom face at which a light-material outlet is disposed; said inner drum is a truncated cone similar to the shape of said outer drum, and straight panel-like blades are disposed on a side face of said inner drum, a gap is formed between said blades and said outer drum, and said feeding port is disposed at said side face of said inner drum close to a top end.

5. The centrifugal separating apparatus according to claim 3, wherein a heavy material anti-adherence device is provided within said drum or on said drum.

6. The centrifugal separating apparatus according to claim 5, wherein said heavy material anti-adherence device is a heavy-material discharging spiral, and said mechanical activation device is an activation spiral with an opposite torsion which is disposed in a open hole of said heavy-material discharging spiral, and said light-material discharging port is a communication-vessel-type discharging pipe which is disposed in a liquid baffle.

7. The centrifugal separating apparatus according to claim 5, wherein said heavy material anti-adherence device is made up of a shaking drum formed in the shape of a truncated cone and a high-frequency shaking device capable of vibrating said shaking drum in a rotational circumference direction.

8. The centrifugal separating apparatus according to claim 7, wherein said mechanical activation device of said centrifugal separating apparatus is said inner drum with an activation spiral, and a relatively large gap is left between said activation spiral and said shaking drum, and a relatively large gap is also left between said activation spiral and said inner drum in the form of a hole or connectors indirectly connected; said activation spiral enables the light materials to overcome their centrifugal force to move toward the top end of said truncated cone-like shaking drum.

9. The centrifugal separating apparatus according to claim 8, wherein the centrifugal separating apparatus comprises a heavy-material discharging spiral and a light-material discharging spiral, and said heavy-material discharging spiral has an opposite torsion direction to that of said activation spiral, while said light-material discharging spiral has the same torsion direction as that of said activation spiral.

10. The centrifugal separating apparatus according to claim 8, wherein an inner wall of said shaking wall is provided with a helical channel with a torsion direction identical to that of said activation spiral and a pitch slightly smaller than that of said activation spiral.
